(19) United States
(12) Patent Application Publication
(10) Pub. No.: US 2017/0057782 A1
(43) Pub. Date: Mar. 2, 2017

(54) IMPROVED ELEVATOR RELEVELING CONTROL

(71) Applicant: Otis Elevator Company, Farmington, CT (US)

(72) Inventors: Randall Keith Roberts, Hebron, CT (US); YiSug Kwon, Farmington, CT (US)

(21) Appl. No.: 15/119,578

(22) PCT Filed: Feb. 19, 2014
(86) PCT No.: PCT/US2014/017082

§ 371 Date: Aug. 17, 2016

(51) Int. Cl. B66B 1/40; B66B 1/44

(52) U.S. Cl. CPC B66B 1/40; B66B 1/44; B66B 9/00

(57) ABSTRACT

A system for releveling an elevator car floor with a landing floor includes a load weight sensor to sense a load weight of an elevator car at a landing floor, and a releveling controller operably connected to the load weight sensor to calculate a corrective velocity for the elevator car based on the load weight and estimates of the effective stiffnesses at the landing floor. A machine is operably connected to the releveling controller with both feedback and feedforward control and the elevator car to apply the corrective velocity to the elevator car thereby reducing a mismatch between the elevator car and the landing floor.

### BACKGROUND

The subject matter disclosed herein relates to elevator systems. More specifically, the subject disclosure relates to improvements in systems and methods of releveling elevator cars of an elevator system.

Maintaining small step mismatches between an elevator car and a landing floor during passenger loading and unloading is one goal of elevator operation. If the mismatch is large, it poses a safety issue in the form of a trip hazard for the passengers entering or exiting the elevator car and can complicate or restrict access to wheelchair-bound passengers. The elevator cars are supported and driven by tension members, for example, belts or ropes. In high rise systems, especially, minimizing the mismatch error between the car and landing sill is difficult due to the elasticity of the tension members, which when coupled with the increased length of the tension members in the high rise system, results in a larger mismatch of the elevator car and landing floor. In addition, in high capacity elevators (ones that can carry a large number of passengers) the rate of change of the load in the car can be high which can create large mismatch errors if the releveling control does not react quickly and correctly to compensate for such position errors. Further, when an elevator brake is released, the machine and its associated drive and control system driving the tension members exhibits an effective torsional spring motion, further increasing the mismatch.

To alleviate the mismatch, sag (the difference between the elevator and landing sill) is typically measured. A corrective velocity is then applied through the machine and its associated driven and control system to the elevator car via the belt or rope to move the elevator car floor into alignment with the landing floor using feedback control. This process is iterative, as the applied corrective velocity may overcorrect or undercorrect the sag, and is inhibited by low frequency elevator car bounce. Further, there often is a delay in the system response during repeated measurement and correction.

### BRIEF DESCRIPTION

In one embodiment, a method of releveling an elevator car floor with a landing floor includes sensing a load weight of an elevator car at a landing floor and calculating a corrective velocity for the elevator car based on the load weight of the elevator car. The corrective velocity, a feed forward control, is added to the conventional feedback signal in the machine, drive, and control system to the elevator car, thereby improving the reduction of a position mismatch between the elevator car and the landing floor.

Additionally or alternatively, in this or other embodiments one or more of known mechanical stiffness or electrical stiffness of the elevator system are utilized to calculate the corrective velocity.

Additionally or alternatively, in this or other embodiments the mechanical stiffness and/or the electrical stiffness are programmed into a computer and utilized at the computer with the load weight to calculate the corrective velocity.

Additionally or alternatively, in this or other embodiments the mechanical stiffness and/or the electrical stiffness are determined dynamically.

Additionally or alternatively, in this or other embodiments the method includes transmitting the corrective velocity to a drive and control system of the elevator system and driving an elevator machine at the corrective velocity.

Additionally or alternatively, in this or other embodiments calculating the corrective velocity and applying the corrective velocity is repeated as the load weight of the elevator car changes.

Additionally or alternatively, in this or other embodiments the load weight is sensed at the elevator car.

Additionally or alternatively, in this or other embodiments the load weight is sensed at a fixed end of a tension member of the elevator stiffness.

In another embodiment, a system for releveling an elevator car floor with a landing floor includes a load weight sensor to sense a load weight of an elevator car at a landing floor, and a releveling controller operably connected to the load weight sensor to calculate a corrective velocity for the elevator car based on the load weight of the elevator car. A machine, drive, and control system is operably connected to the releveling controller and the elevator car to apply the corrective velocity to the elevator car thereby reducing a mismatch between the elevator car and the landing floor.

Additionally or alternatively, in this or other embodiments one or more of known mechanical stiffness or electrical stiffness of the elevator system are utilized to calculate the corrective velocity at the releveling controller.

Additionally or alternatively, in this or other embodiments the corrective velocity is repeatedly calculated and applied as the load weight of the elevator car changes.

Additionally or alternatively, in this or other embodiments the load weight sensor is disposed at the elevator car.

Additionally or alternatively, in this or other embodiments the load weight sensor is disposed at a fixed end of a tension member of the elevator.

In yet another embodiment, an elevator system includes an elevator car located in a hoistway and movable between two or more landing floors of the hoistway. A tension member is operably connected to the elevator car to suspend and/or drive the elevator car along the hoistway. A machine is operably connected to the tension member to effect the movement of the elevator car along the hoistway. A releveling system is operably connected to the machine and includes a load weight sensor to sense a load weight of the elevator car at a landing floor of the two or more landing floors. A releveling controller is operably connected to the load weight sensor to calculate a corrective velocity for the elevator car based on the load weight of the elevator car and transmit the corrective velocity to the machine such that when applied by the machine, the corrective velocity reduces a positional mismatch between the elevator car and the landing floor.

Additionally or alternatively, in this or other embodiments one or more of known mechanical stiffness or electrical stiffness of the elevator system are utilized to calculate the corrective velocity at the releveling controller.

Additionally or alternatively, in this or other embodiments the corrective velocity is repeatedly calculated and applied as the load weight of the elevator car changes.

Additionally or alternatively, in this or other embodiments the load weight sensor is disposed at the elevator car.

Additionally or alternatively, in this or other embodiments the load weight sensor is disposed at a fixed end of the tension member.

Additionally or alternatively, in this or other embodiments the tension member is one of a rope or a belt.

### BRIEF DESCRIPTION OF THE DRAWINGS

FIG. 1A is a schematic of an exemplary elevator system having a 1:1 roping arrangement;

FIG. 1B is a schematic of another exemplary elevator system having a different roping arrangement;

FIG. 1C is a schematic of another exemplary elevator system having a cantilevered arrangement;

FIG. 2 is a schematic of a releveling system for an elevator system.

The detailed description explains the invention, together with advantages and features, by way of examples with reference to the drawings.

### DETAILED DESCRIPTION

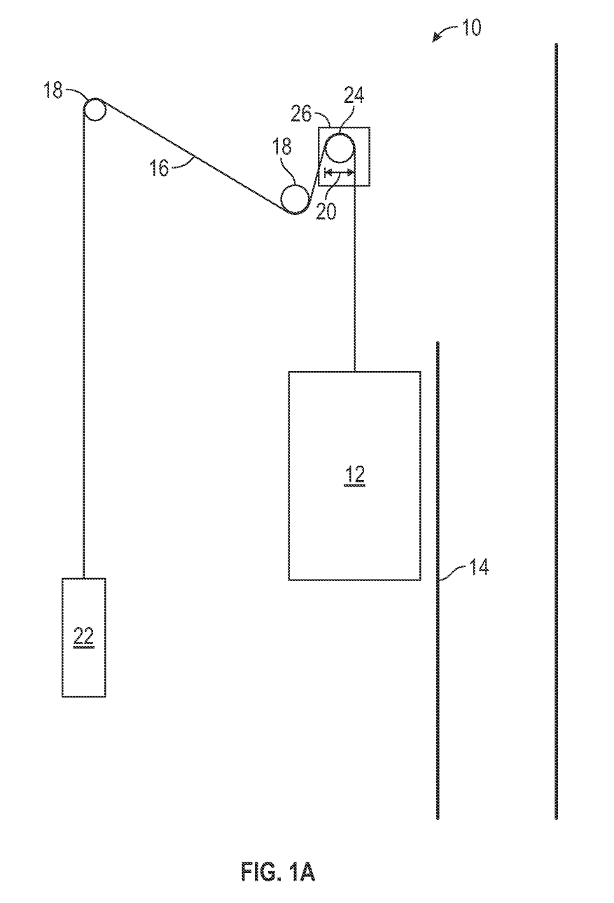

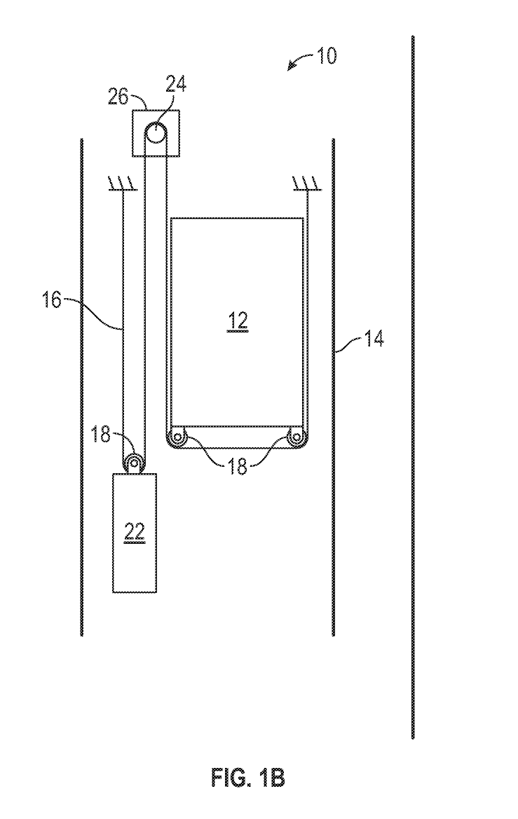

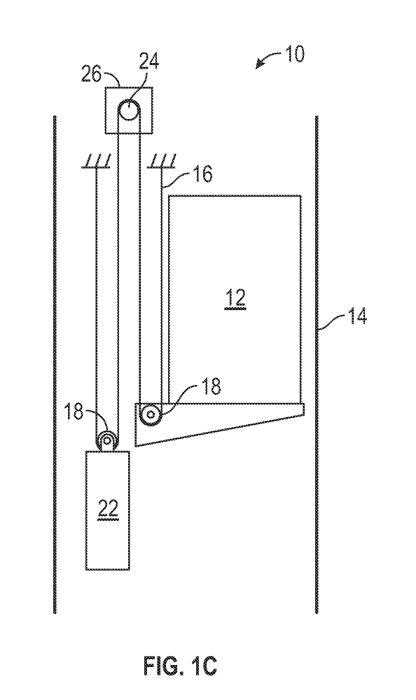

Shown in FIGS. 1A, 1B and 1C are schematics of exemplary traction elevator systems 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more tension members 16. The tension member 16 may be, for example a rope of a coated steel belt. The one or more tension members 16 interact with one or more sheaves 18 to be routed around various components of the elevator system 10. The one or more tension members 16 could also be connected to a counterweight 22, which is used to help balance the elevator system 10 and reduce the difference in belt tension on both sides of a traction sheave 24 during operation.

The traction sheave 24 is driven by a machine 26. Movement of the traction sheave 24 by the machine 26 drives, moves and/or propels (through traction) the one or tension members 16 that are routed around the traction sheave 24.

In some embodiments, the elevator system 10 could use two or more tension members 16 for suspending and/or driving the elevator car 12. In addition, the elevator system 10 could have various configurations such that either both sides of the one or more tension members 16 engage the one or more sheaves 18 (such as shown in the exemplary elevator systems in FIGS. 1A, 1B or 1C) or only one side of the one or more tension members 16 engages the one or more sheaves 18. In addition, the elevator system 10 could have multiple elevator cars 12 supported by the same elevator structural frame in the hoistway 14, such as in double deck or triple deck configurations, or other multi-deck systems.

FIG. 1A provides a 1:1 roping arrangement in which the one or more tension members 16 terminate at the car 12 and counterweight 22. FIGS. 1B and 1C provide different roping arrangements. Specifically, FIGS. 1B and 1C show that the car 12 and/or the counterweight 22 can have one or more sheaves 18 thereon engaging the one or more tension members 16 and the one or more tension members 16 can terminate elsewhere, typically at a structure within the hoistway 14 (such as for a machineroomless elevator system) or within the machine room (for elevator systems utilizing a machine room). The number of sheaves 18 used in the arrangement determines the specific roping ratio (e.g., the 2:1 roping ratio shown in FIGS. 1B and 1C or a different ratio). FIG. 1C also provides a cantilevered type elevator. The present invention could be used on elevator systems other than the exemplary types shown in FIGS. 1A, 1B and 1C.

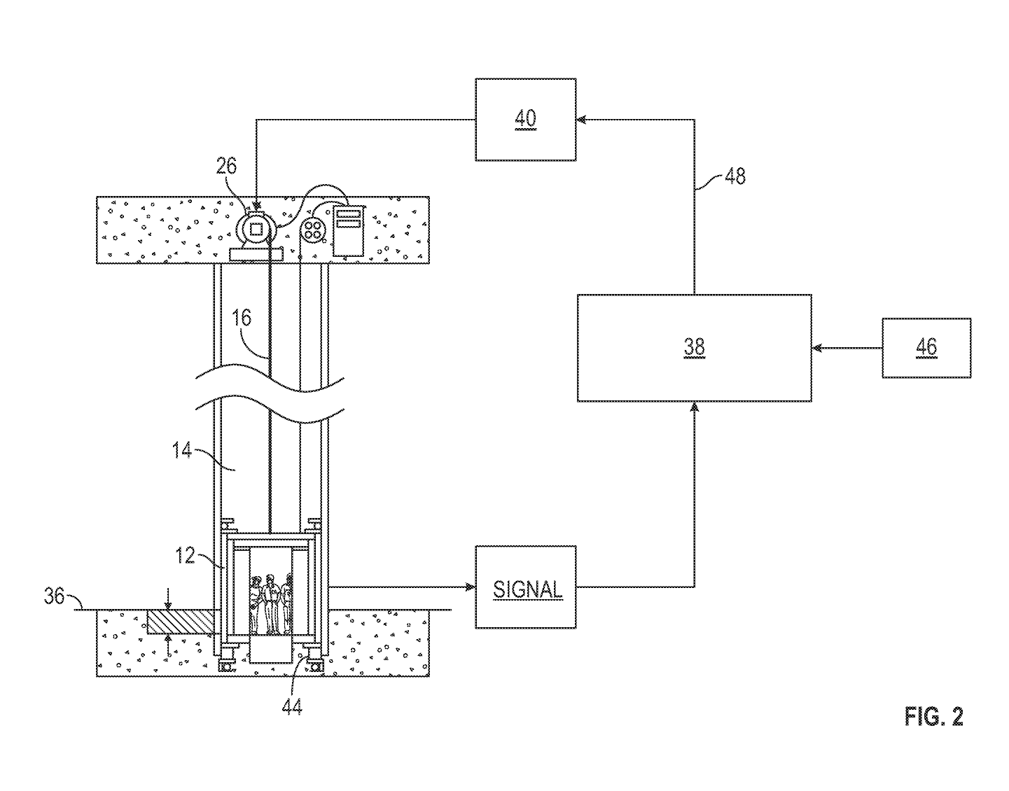

Referring now to FIG. 2, a schematic of a releveling system is illustrated. As shown the elevator car 12 is supported in the hoistway 14 by the tension member 16. The tension member 16 is connected to the machine 26, which is fixed in the hoistway 14. The hoistway 14 includes a number of landing floors 36 at which the elevator car 12 may stop along its travel. A releveling controller, for example, a computer 38 is operably connected to the elevator system 10 via a drive control system 40, which controls operation of the machine 26.

When the elevator car 12 stops at a selected landing floor 36, the computer 38 receives a load weighing signal from a load weight sensor 44 located, for example, at the elevator car 12 or at a fixed end of the tension member 16. In multi-deck elevator systems there may be multiple load weight sensor signals from each landing floor 36 that are combined and feed into the computer 38. The computer 38 uses the load weighing signal, together with mechanical and electrical stiffness data 46 about the elevator system 10 to calculate a corrective velocity 48 output to the drive control system 40. The stiffness data 46 is derived from known tension member 16 construction, machine 26 effective rotational stiffness due from mechanical compliance and electrical compliance of the associated drive control system 40, and the like, and the landing floor location, and may be preprogrammed into the computer 38, or alternatively, assessed or estimated dynamically. The drive control system 40 effective electrical stiffness can be estimated from its control components (such as the motor speed encoder) and its feedback control logic (such as the servo settings of integral and proportional gains). The load weighing signal is found to be generally very clean, free from electronic noise, and is a good proactive indication of the required car 12 position correction. As passengers enter and exit the elevator car 12, the load weighing signal changes, and the corrective velocity 48 output to the drive control system 40 is changed to dynamically correct the elevator car 12 position, thereby preventing trip hazards, and without positional feedback from the elevator car thereby increasing quickness of system response.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of releveling an elevator car floor with a landing floor comprising:
sensing a load weight of an elevator car at a landing floor;
calculating a corrective velocity for the elevator car based on the load weight of the elevator car; and
applying the corrective velocity to the elevator car, thereby reducing a mismatch between the elevator car and the landing floor.

2. The method of claim 1, further comprising utilizing one or more of known mechanical stiffness or electrical stiffness of the elevator system to calculate the corrective velocity.

3. The method of claim 2, wherein the mechanical stiffness and/or the electrical stiffness are programmed into a computer and utilized at the computer with the load weight to calculate the corrective velocity.

4. The method of claim 2, wherein the mechanical stiffness and/or the electrical stiffness are determined dynamically.

5. The method of claim 1, further comprising:
transmitting the corrective velocity to a drive control system of the elevator system; and
driving an elevator machine at the corrective velocity.

6. The method of claim 1, further comprising repeating calculating the corrective velocity and applying the corrective velocity as the load weight of the elevator car changes.

7. The method of claim 1, wherein the load weight is sensed at the elevator car.

8. The method of claim 1, wherein the load weight is sensed at a fixed end of a tension member of the elevator stiffness.

9. A system for releveling an elevator car floor with a landing floor comprising:
a load weight sensor to sense a load weight of an elevator car at a landing floor;
a releveling controller operably connected to the load weight sensor to calculate a corrective velocity for the elevator car based on the load weight of the elevator car; and
a machine operably connected to the releveling controller and the elevator car to apply the corrective velocity to the elevator car thereby reducing a mismatch between the elevator car and the landing floor.

10. The system of claim 9, further comprising additionally utilizing one or more of known mechanical stiffness or electrical stiffness of the elevator system to calculate the corrective velocity at the releveling controller.

11. The system of claim 9, wherein the corrective velocity is repeatedly calculated and applied as the load weight of the elevator car changes.

12. The system of claim 9, wherein the load weight sensor is disposed at the elevator car.

13. The system of claim 9, wherein the load weight sensor is disposed at a fixed end of a tension member of the elevator.
